(19) United States
(12) Patent Application Publication
(10) Pub. No.: US 2023/0081011 A1
(43) Pub. Date: Mar. 16, 2023

(54) IMPROVED METHOD FOR THE PACKAGING AND LONG-TERM PRESERVATION OF MEAT PRODUCTS WITHOUT COLD CHAIN

(71) Applicants: Augustin Roman Curutchet, Buenos Aires (AR); Pablo Roman Curutchet, Buenos Aires (AR)

(72) Inventors: Pablo Roman Curutchet, Buenos Aires (AR); Sergio Vaudagna, Buenos Aires (AR)

(21) Appl. No.: 17/799,460

(22) PCT Filed: Dec. 15, 2020
(86) PCT No.: PCT/EP2020/086084

§ 371 Date: Aug. 12, 2022

(30) Foreign Application Priority Data
Feb. 21, 2020 (AR) P20200100562

(51) Int. Cl. A23B 4/023; A23B 4/005; B65B 25/06; A23B 4/015; A23L 13/70

(52) U.S. Cl. CPC A23B 4/023; A23B 4/0056; B65B 25/067; A23B 4/015; A23L 13/72; A23V 2002/00

(57) ABSTRACT

An improved method for the packaging and long-term preservation of meat products without cold chain, which avoids the loss of liquids during radiation, in order to improve the preservation and maintenance of the organoleptic properties of meat pieces.

### FIELD OF THE INVENTION

The present invention relates to the field of procedures or methods used for the packaging and preservation of meat products, and more particularly relates to an improved method for the packaging and long-term preservation of meat products without cold chain that avoids the loss of liquid during the packaging process, in order to allow its transport and storage for a certain time without the necessary use of a cold chain for its preservation, and also allowing better preservation of the organoleptic properties of the pieces of meat.

### DESCRIPTION OF PRIOR ART

Since immemorial times it is known that every cut or piece of meat immersed in a saturated salt solution and then put to dry, is “cured”, obtaining a hard product, not very pleasant in appearance, but that allows it to be preserved for a long time without decomposing, even when its nutritional and organoleptic properties are very low or deficient.

With the advent of refrigeration facilities, already from approximately 1850-60 onwards it was possible to freeze the pieces of meat, and transport them in refrigerated wagons, and then keep them in cold rooms, either for maritime transport, or in the big cities, until their retail sale. This process is often referred to as a “cold chain”, and it works very well as long as the cold chain is not interrupted.

However, there are places where such facilities do not exist, either because the cost of the facilities is not justified, or due to technological and equipment deficiencies that still exist in some nations of the world.

These installation and equipment deficiencies prevent or hinder the placement of large volumes of export quotas for meat products, because even when the meat pieces are transported in refrigerated vessels, it is useless if, upon arrival at their destination, they lack adequate cold rooms for preserving the product.

This problem, briefly raised here, prevents the penetration and capture of new non-traditional markets for meat products, with the consequent losses of opportunity.

Then there are other more primitive methods for curing meat, but all of them, practiced since ancient times, consist of drying the meat under the protection of concentrated NaCl and nitrites, or smoking the meat, etc. but none of these known methods allow having a soft meat ready for consumption or for cooking, as if it were a freshly processed piece of meat with most of its juices, being tender and soft.

Other processes, such as corned beef, although they may dispense with the cold chain for their preservation, need hermetic tinplate containers for their correct storage and packaging, process and supplies that are themselves expensive.

As a result of the drawbacks of the prior art, the same holder of the present application had developed a method for the packaging and long-term preservation of meat products without cold chain, in accordance with the Patent Application AR P030104507, whose content can be considered as a reference of the present invention. The method included the step of selecting meat cuts, chopping them up and/or stripping them if necessary, eliminating fat and minor trimmings, obtaining pieces of weight and size within a uniform range, wherein the following steps are included:
a) Each piece of meat was injected with a brine solution containing at least NaCl with a concentration necessary to achieve a maximum of 20% of the weight of the injected meat cut;
b) Once all the pieces of the same batch under treatment have been injected, the meat is massaged for a time within a range between 8 to 24 hours under pressure and reduced temperatures;
c) Then this same batch is removed from the massager and each piece of meat is introduced into a hermetically closed bag of an impermeable polymer and the batch of cuts of meat thus bagged was subjected to a cooking process in hot water until a temperature of 70 to 85° C. is achieved in the center of the larger piece for a time of 15 to 30 minutes;
d) Then the batch of bags with meat is removed from the cooking bath and the meat is removed from each cooking bag, and a cooling process is carried out until a temperature of around 26° C. is reached in the geometric center of the pieces of meat;
e) After finishing the cooling step, each piece of pre-cooked meat is packed;
f) Once the pieces of meat are packed, they are subjected to a freezing process at around −14° C.
g) The pieces of meat packed in this way are subjected to a radiation process until a minimum total dose of 15 kGy is accumulated.

Although step f) was proposed to minimize the effect of the radiation treatment on the generation of free radicals and, consequently, lipid oxidation, the holder has observed that when the product is thawed after the radiation step, it has a noticeable loss of liquid which is retained in the product container. This loss of liquid is due to the syneresis, due to the effect of freezing, of the gel formed in the meat pieces after the brine injection, massage and cooking steps.

By virtue of the current state of the art available for the packaging and long-term preservation of meat products without the need for cold chains, the inventor has continued to seek and develop improvements in the process in order to avoid the aforementioned drawbacks.

### BRIEF DESCRIPTION OF THE INVENTION

It is therefore an object of the present invention to provide an improved method that avoids the loss of liquid from the meat pieces after the brine injection, massaging, cooking and freezing steps thereof.

It is also another object of the present invention to keep them fit for consumption for a period of up to 8 months, without the intervention of a cold chain for their preservation, being kept at temperatures of up to 30° C. without deterioration.

It is another object of the present invention that the meat cuts can be packaged in containers of low-cost recyclable material, such as plastic bags, or cardboard boxes, or a combination of both, both for their transport and for their storage and preservation, without the content suffering any deterioration.

Another object of the present invention is a method that, by avoiding the loss of liquid, allows improving the preservation of the organoleptic conditions of the meat, that is, keeping said cuts of meat soft, tender, with a large part of their juices intact inside it, and with a pleasant color and flavor.

Still another object of the present invention is an improved method for the packaging and long-term preservation of meat products without cold chain, which includes the step of selecting meat cuts, chopping them and/or stripping them if necessary, eliminating the fats and minor trimmings, obtaining pieces of weight and size within a uniform range, which includes the steps of:
a) Injecting each piece of meat with a brine solution containing at least NaCl in an amount of up to a maximum of 20% of the weight of the meat cut into which it has been injected;
b) Once all the pieces of the same batch under treatment have been injected, the meat is massaged for a time of between 8 to 24 hours under reduced pressure between 33.863 Pa (10″ HG) and 50795 Pa (15″ HG) and at temperatures between −1° C. and 3° C.;
c) Removing this batch from the massager and placing each piece of meat in a hermetically closed bag made of an impermeable polymer, subjecting the batch of meat cuts thus bagged to a cooking process in hot water until a temperature of 70 to 85° C. is achieved in the center of the larger piece for a time of 15 to 30 minutes;

the method being characterized in that it comprises the steps of:
d) Once cooked, the pieces are cooled until reaching a temperature of around 26° C. in their thermal center;
e) Once cooled, the bags with meat are removed from the cooking bath and the meat pieces are removed from each cooking bag, subsequently carrying out the vacuum packaging of the meat pieces in bags of multi-layer plastic material;
f) Once the meat pieces have been packed, they are cooled until reaching a temperature in the range 0 to 2° C. in the thermal center; and
g) The pieces of meat packed in this way are subjected to a radiation process until a minimum total dose of 15 kGy is accumulated.

### BRIEF DESCRIPTION OF THE DRAWINGS

For greater clarity and understanding of the object of the present invention, it has been illustrated in a figure, in which the invention has been represented in one of the preferred embodiments, all by way of example, wherein:

FIG. 1 shows a diagram of the steps corresponding to the method according to the present invention.

### DETAILED DESCRIPTION OF THE INVENTION

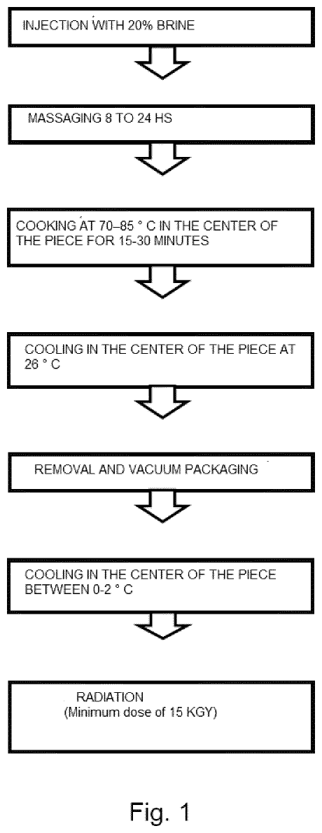

Referring to FIG. 1, it can be seen that the invention consists of an improved method for the packaging and long-term preservation of meat products without cold chain, which includes the step of selecting meat cuts, chopping them up and/or stripping them if necessary, eliminating fat and minor trimmings, obtaining pieces of weight and size within a uniform range, wherein the method comprises the following steps:
a) Injecting each piece of meat with a brine solution containing at least NaCl in an amount of up to a maximum of 20% of the weight of the meat cut into which it has been injected;
b) Once all the pieces of the same batch under treatment have been injected, the meat is massaged for a time of between 8 to 24 hours under reduced pressure between 33.863 Pa (10″ HG) and 50795 Pa (15″ HG) and at temperatures between −1° C. and 3° C.;
c) Removing this batch from the massager and placing each piece of meat in a hermetically closed bag made of an impermeable polymer, subjecting the batch of meat cuts thus bagged to a cooking process in hot water until a temperature of 70 to 85° C. is achieved in the center of the larger piece for a time of 15 to 30 minutes;
d) Once cooked, the pieces are cooled until reaching a temperature of around 26° C. in their thermal center;
e) Once cooled, the bags with meat are removed from the cooking bath and the meat pieces are removed from each cooking bag, subsequently carrying out the vacuum packaging of the meat pieces in bags of multi-layer plastic material;
f) Once the meat pieces have been packed, they are cooled until reaching a temperature in the range 0 to 2° C. in the thermal center;
g) The pieces of meat packed in this way are subjected to a radiation process until a minimum total dose of 15 kGy is accumulated.

It should be noted that in step (e), it is optional to pack the pieces in bags made of “BTECIN” material from the firm Sealed Air Co. of Argentina, or any other packaging for this purpose, and then pack the bags in cardboard boxes.

In order to illustrate a practical way of implementing the above-mentioned steps of the method, a block diagram with the main indicated sequential operations is attached in FIG. 1, and in support of the obtaining example for each of said steps, it should be understood that specific considerations expressed for the following examples reflect conditions of a laboratory pilot test, conditions that may vary slightly in batches produced on an industrial scale.

Raw Material Used:

For each test, work was done on 40 kg of meat chopped into pieces of approximately 10 kg each, each bag containing a “topside of beef” cut, that is, stripped cuts chosen from the supraspinatus, infraspinatus, trapezius, deltoid muscles, latissimus dorsi, triceps brachii and tensor fasciae antebrachialis muscles. Trimmings and fat pieces were removed. Each cut, trimmings and pieces of fat removed were weighed separately for each bag.

Injection:

The formulation of the solution for injection was defined by determining the concentrations of nitrite and sodium chloride necessary to achieve in the processed product a concentration of 3.5% NaCl/100 g of cooked product and an amount not exceeding 150 ppm of sodium nitrite in the cooked product, corresponding to approximately 20% of the weight of the raw cut. A Dick Lokespritze Esslingen A. NX single needle injector was used.

Massaging:

Massaging is necessary for the correct uniform distribution of the injected brine throughout the piece under treatment. A “KOCH” massager drum was used, with a maximum capacity of 90 kg and with a drum rotation range of 0 to 9 r.p.m. The 40 kg of chopped meat were loaded into the drum, a vacuum of 15″ Hg was produced inside and it was operated at 5 rpm, under refrigeration at −1° C. Two massage tests were carried out; one for 8 hours and the other for 24 hours.

Cooking:

The cooking step was determined to achieve in the center of the pieces a cooking time of 20 minutes at 75° C. For this, an autoclave with water showers, Barriquand Steriflow brand, Microflow model, was used, simulating cooking in a water bath. Prior to this, each piece of meat from the batch under treatment was enclosed in high-density polyethylene bags from the company CT Plast. The treatment water initially had a temperature of 80° C. and this temperature was maintained until the largest cut reached the aforementioned temperature of 75° C., counting 20 minutes of cooking from that moment.

Cooling:

After cooking, each piece was cooled to approximately 26° C.

Vacuum Packed:

After cooling, each piece of meat was vacuum packed in bags such as the “BTECIN” bags from Sealed Air Co. of Argentina.

Packing:

Cardboard boxes 40 cm wide, 60 cm long and 16 cm high are used, containing 6 pieces per box. This step is optional and can be done after the next cooling step.

Cooling:

After the packaging of the meat pieces, they are cooled until reaching a temperature in the range of 0° C. to 2° C. in the thermal center. The cooling can be done directly to the vacuum-packed meat pieces or to pieces packed in cardboard boxes.

Radiation:

The boxes were radiated with gamma rays at the Ezeiza Atomic Center until a minimum dose of 15 kGy was accumulated.

It is highlighted that the brine solution contains 1.2 g/Kg. of sodium nitrite solution and 19.5% of NaCl, while the massaging step is carried out at a reduced pressure of 15″ Hg, at 1° C. for 8 hours. In turn, the additional advantages and test tables are sufficiently described in Patent Application AR P030104507 and for such reasons, we will not go into descriptive details about them.

In this way, the improved method of the present invention is described, which avoids liquid losses by virtue of the replacement of steps d) to f) that now allow having a refrigerated, non-frozen product at a temperature in the range from 0 to 2° C. and, under these conditions, radiating the meat pieces, so that now, by not losing liquid, the organoleptic properties are maintained much better.

1. An improved method for the packaging and long-term preservation of meat products without cold chain, which includes the step of selecting meat cuts, cutting them and/or stripping them if necessary, eliminating fats and minor trimmings, obtaining pieces of weight and size within a uniform range, wherein it comprises the steps of:
a) Injecting each piece of meat with a brine solution containing at least NaCl in an amount of up to a maximum of 20% of the weight of the meat cut into which it has been injected;
b) Once all the pieces of the same batch under treatment have been injected, the meat is massaged for a time of between 8 to 24 hours under reduced pressure between 33.863 Pa (10″ HG) and 50795 Pa (15″ HG) and at temperatures between −1° C. and 3° C.;
c) Removing this batch from the massager and placing each piece of meat in a hermetically closed bag made of an impermeable polymer, subjecting the batch of meat cuts thus bagged to a cooking process in hot water until a temperature of 70 to 85° C. is reached in the center of the larger piece for a time of 15 to 30 minutes;
the method being characterized in that it comprises the steps of:
d) Once cooked, the pieces are cooled until reaching a temperature of around 26° C. in their thermal center;
e) Once cooled, the bags with meat are removed from the cooking bath and the meat pieces are removed from each cooking bag, subsequently carrying out the vacuum packaging of the meat pieces in bags of multi-layer plastic material;
f) Once the meat pieces have been packed, they are cooled until reaching a temperature in the range 0 to 2° C. in the thermal center; and
g) The pieces of meat packed in this way are subjected to a radiation process until a minimum total dose of 15 kGy is accumulated.

2- Method according to claim 1, characterized in that the brine solution contains 1.2 g/Kg. of sodium nitrite solution and 19.5% NaCl.

3- Method according to claim 1, characterized in that the massaging step is carried out at a reduced pressure of 15″ Hg, at 1° C. for 8 hours.
